(19) United States
(12) Patent Application Publication
(10) Pub. No.: US 2021/0283436 A1
(43) Pub. Date: Sep. 16, 2021

(54) ELEVATED HORIZONTAL SAFETY LIFELINE APPARATUS AND METHOD

(71) Applicant: Andrew Arena, Waccabuc, NY (US)

(72) Inventor: Andrew Arena, Waccabuc, NY (US)

(21) Appl. No.: 16/819,376

(22) Filed: Mar. 16, 2020

(51) Int. Cl. A62B 35/00

(52) U.S. Cl. CPC A62B 35/005; A62B 35/0068; A62B 35/0056

(57) ABSTRACT

An apparatus including a lifeline having a first end and an opposing second end; a support structure, wherein the first end and the second end of the lifeline are supported by the support structure such that there is a distance between the first end and the opposing second end; and a structure for holding one or more persons above a ground surface; wherein the support structure is configured to be moved without causing the structure for holding one or more persons to be moved; and the structure for holding one or more persons be configured to be moved without causing the support structure to be moved. The support structure may include first and second posts; wherein each of the first and second posts be configured to be adjusted in height above a ground surface to cause a height of the lifeline above the ground surface to be adjusted.

### FIELD OF THE INVENTION

This invention relates to safety lifeline fall protection.

### BACKGROUND OF THE INVENTION

Present industry and typical horizontal fall protection systems are designed to provide fall protection, restrain and arrest to workers when working on a surface that is four (4) feet and greater in vertical height by which also provides limited uninhibited movement horizontally for a worker between two fixed points. Typical applications for temporary horizontal lifelines include use on construction sites, structural steel erection, bridge work, shaft work, mechanical installations, all leading edge work above four (4) feet, general industry and superstructure work to name a few. Typical anchor points used to apply pre-engineered horizontal fall protection equipment are normally permanent structures such as but not limited to structural steel columns, structural concrete, and other permanent surfaces anchored to a structure. These horizontal lifeline systems and anchorage points must comply with OSHA (1910 General Industry/1926 Construction) and the American National Specifications Institute (ANSI) requirements for fall protection and horizontal fall protection systems. These typical horizontal lifeline systems do not provide vertical height adjustments through the use of adjustable vertical posts that are positioned adjacent to a working surface, above a working surface and/or do not allow for the fall protection system to be independent of a structure for holding one or more persons above a ground surface. Typical horizontal lifelines are then connected post to post or point to point and consist of a cable or rope that is attached to two or more anchor points. A horizontal lifeline can be used in combination with a personal fall arrest system to arrest, restrain, stop a fall and to limit the vertical distance of a worker when falling downward. A horizontal lifeline can also be used in combination with a body harness, lanyard or self-retracting lifeline to serve as a fall restraint system that limits a worker's ability to reach a leading edge condition and arrest, restrain, and stop a worker to fall vertically downward. These fall protection systems are also well suited to accommodate more than one worker at a time.

General industry and the building trade industry has long been considered of the most dangerous industries to be employed. In general industry and the building trades, worker safety is protected by the Occupational Health and Safety Act (OSHA), which is governed by the department of labor. However, workers still remain at risk when working at heights of four feet and greater. Presently general industry and the building trades industry uses various safety protection systems to prevent, the free but limited horizontal movement for workers when working at four foot or greater. The problem with safety equipment in today's general industry and building trades industry is that horizontal lifeline equipment do not provide vertical height adjustments through the use of adjustable vertical posts that are positioned adjacent to a working surface, above a working surface and/or do not allow for the fall protection system to be independent of a structure for holding one or more persons above a ground surface. Prior horizontal life line systems do not provide the vertical adjustability of such equipment for point to point movement at elevations four foot or greater, nor do prior horizontal lifeline systems provide vertical adjustments to allow for the horizontal lifeline equipment to be placed above a working surface and above workers from the surface where the workers are standing. Prior horizontal fall protection systems are only established at one fixed point to point location and do not provide the vertical adjustment in height which prevents the horizontal lifeline equipment to be placed above the workers from the surface where they are working from and which prevents the horizontal lifeline equipment to be placed from the surface where the workers are standing from.

### SUMMARY OF THE INVENTION

According to the department of labor, falls are the leading cause of fatalities within the building trades and/or construction industry (osha.gov/2017 BLS Data).

There needs to be a solution to reducing falls and worker injury related to falls when working at four foot or greater and especially on vertical projects where hazards exist at fifteen, twenty, twenty-five, thirty feet, and greater that allows workers to use horizontal lifeline equipment for uninhibited movement horizontally, without vertical restrictions in height and without having to be structurally dependent on anchoring to that workers work surface. Many general industry and building trades' horizontal lifeline safety equipment are restricted vertically in height for placement above a work surface and above a worker from the surface where the worker is working from.

In at least one embodiment of the present application an elevated horizontal safety lifeline system, apparatus, and method is provided which is a solution for workers to use when working at four foot or greater vertically in height and for unobstructed horizontal lateral movement. This horizontal lifeline system provides an overhead horizontal lifeline system with two posts that are adjustable in vertical height including a horizontal lifeline by which workers are attached to, placed above the working surface or above the worker from which a worker is standing in order to prevent, restrain and arrest workers falling to a surface below. In at least one embodiment, the elevated horizontal lifeline system, apparatus and/or method has the option to be configured with materials that achieve the structural engineering standards for horizontal personal fall arrest systems as required by the Occupational Health and Safety administration (OSHA) and the American National Standards Institute (ANSI). In at least one embodiment, the system, apparatus and/or method will be in configured and engineered to be compliant with all regulatory fall protection standards and requirements for workers when using this system, apparatus and/or method as a horizontal lifeline system and as a personal fall restraint system while working at a level of four (4) foot and greater in height.

In at least one embodiment, an apparatus is provided comprising: a lifeline having a first end and an opposing second end; a support structure, wherein the first end and the second end of the lifeline are supported by the support structure such that there is a distance between the first end and the opposing second end; and a structure for holding one or more persons above a ground surface. In at least one embodiment, it is critical that the support structure be configured to be moved without causing the structure for holding one or more persons to be moved; and that the structure for holding one or more persons be configured to be moved without causing the support structure to be moved.

The support structure may include first and second posts; wherein in at least one embodiment, it is critical that each of the first and second posts be configured to be adjusted in height above a ground surface to cause a height of the lifeline above the ground surface to be adjusted.

In at least one embodiment, a method is provided, comprising the steps of setting up a support structure to be independent of a structure for holding one or more persons above a ground surface; and attaching a first end of a lifeline to the support structure and an opposing second end of the lifeline to the support structure so that there is a distance between the first end and the opposing second end; wherein the support structure is configured to be moved without causing the structure for holding one or more persons to be moved; and wherein the structure for holding one or more persons is configured to be moved without causing the support structure to be moved.

The support structure may include first and second posts; wherein each of the first and second posts is configured to be adjusted in height above a ground surface to cause a height of the lifeline above the ground surface to be adjusted.

### BRIEF DESCRIPTION OF THE DRAWINGS

FIG. 1 is a simplified diagram of an apparatus, system, and method in accordance with a first prior art lifeline technique, along with a simplified rendition of a human being;

FIG. 2 is a simplified diagram of an apparatus, system, and method in accordance with a second prior art lifeline technique, along with a simplified rendition of a human being;

FIG. 3 is a simplified diagram of an apparatus, system, and method in accordance with a third prior art lifeline technique, along with a simplified rendition of a human being; and

FIG. 4 is a simplified diagram of an apparatus, system, and method in accordance with an embodiment of the present invention, and two simplified renditions of two human beings.

### DETAILED DESCRIPTION OF THE DRAWINGS

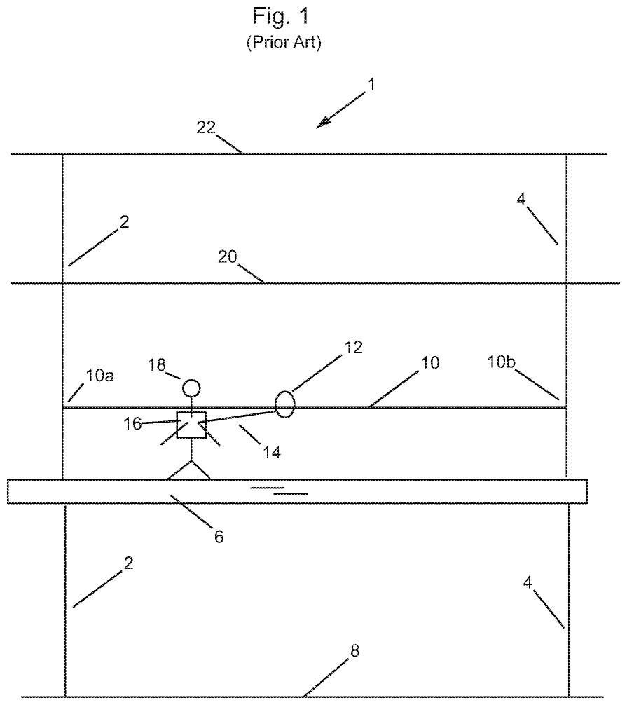

FIG. 1 is a simplified diagram 1 of an apparatus, system, and method in accordance with a first prior art lifeline technique, along with a simplified rendition of a human being.

FIG. 1 shows columns 2 and 4, and a floor 6, which typically are permanent structures. The floor 6 typically has a first end fixed to column 2 and an opposing second end fixed to column 4, so that the floor 6 is level and/or substantially parallel to a ground surface 8, at a height above the ground surface 8. The columns 2 and 4 may extend above the floor 6. A lifeline 10 may be provided which typically may be a cord. One end of the lifeline 10 is fixed at point 10a to the column 2 and an opposing end of the lifeline 10 is fixed at a point 10b to the column 4.

A ring or attachment device 12 is connected to the lifeline 10. A first end of a lanyard or cord 14 is connected to the attachment device 12, and a second opposing end of the lanyard or cord 14 is connected to a harness 16. The harness 16 is worn by a person 18.

Generally if the person 18 falls off of the floor 6, the person's fall will be arrested; the person 18 will be prevented from hitting the ground surface 8; and the person 18 will be supported by the lifeline 10, the attachment device 12, the cord 14, and the harness 16.

The components 20 and 22 may be additional permanent floor structures.

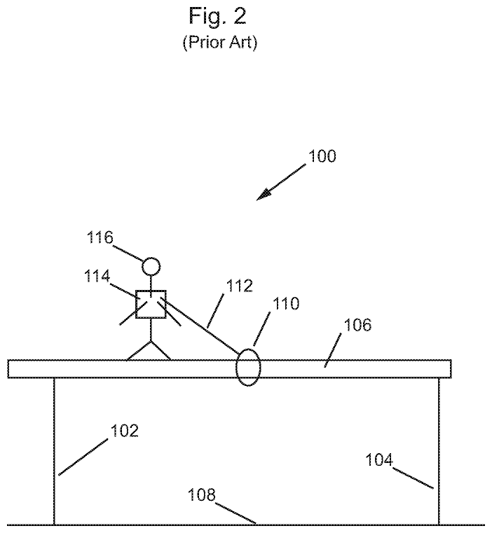

FIG. 2 is a simplified diagram 100 of an apparatus, system, and method in accordance with a second prior art lifeline technique, along with a simplified rendition of a human being 116.

FIG. 2 shows columns 102 and 104, and a floor or structural components of a floor 106, which typically are permanent structures. The floor 106 typically has a first end fixed to column 102 and an opposing second end fixed to column 104, so that the floor 106 is level and/or substantially parallel to a ground surface 108, at a height above the ground surface 108. The columns 102 and 104 may extend above the floor 106.

A ring or attachment device 110 is connected to the floor or structural components of a floor 106. A first end of a lanyard or cord 112 is connected to the attachment device 110, and a second opposing end of the lanyard or cord 112 is connected to a harness 114. The harness 114 is worn by a person 116.

Generally if the person 116 falls off of the floor or structural components of a floor 106, the person's fall will be arrested; the person 116 will be prevented from hitting the ground surface 108; and the person 18 will be supported by the attachment device 110 (as attached to the floor 106), the cord 112, and the harness 114.

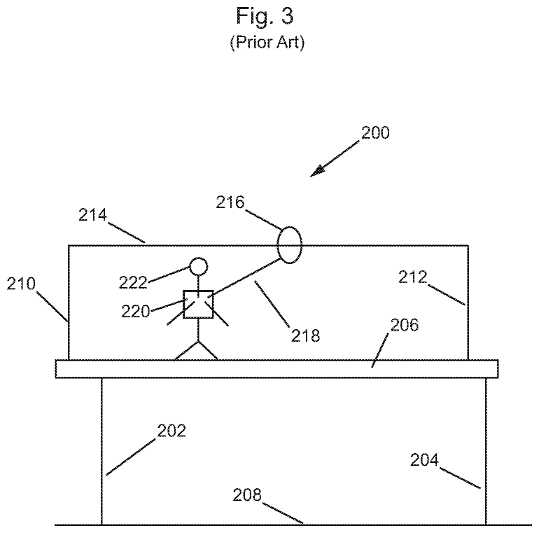

FIG. 3 is a simplified diagram 200 of an apparatus, system, and method in accordance with a third prior art lifeline technique, along with a simplified rendition of a human being 222.

FIG. 3 shows columns 202 and 204, and a floor or structural components of a floor 206, which typically are permanent structures. The floor 206 typically has a first end fixed to column 202 and an opposing second end fixed to column 204, so that the floor 206 is level and/or substantially parallel to a ground surface 208, at a height above the ground surface 208. The columns 202 and 204 may extend above the floor 206.

FIG. 3 shows a lifeline or cord 214 having a first end connected to a column 210 and a second end connected to a column 212. A ring or attachment device 216 is connected to the lifeline or cord 214. A first end of a lanyard or cord 218 is connected to the attachment device 216, and a second opposing end of the lanyard or cord 218 is connected to a harness 220. The harness 220 is worn by a person 222.

Generally if the person 222 falls off of the floor or structural components of a floor 206, the person's fall will be arrested; the person 222 will be prevented from hitting the ground surface 208; and the person 222 will be supported by the attachment device 216, the lifeline 214 (as supported by columns 210 and 212), the cord 218, and the harness 220.

For a known lifeline or cord 214 as in FIG. 3, the lifeline or cord 214 may typically be at a mid body level of the person 222 rather than above the person 222 as shown in FIG. 3, however, lifeline or cord 214 is shown above the person 222 for descriptive purposes so that the lifeline 214 can be clearly seen in FIG. 3, without being obscured by the person 222 or the lanyard or cord 218. When the cord 214 is at a mid body level, the attachment device 216, which is attached to cord 214, would also be at a mid body level, and the columns 210 and 212 would also be shortened to be in line with lifeline or cord 214.

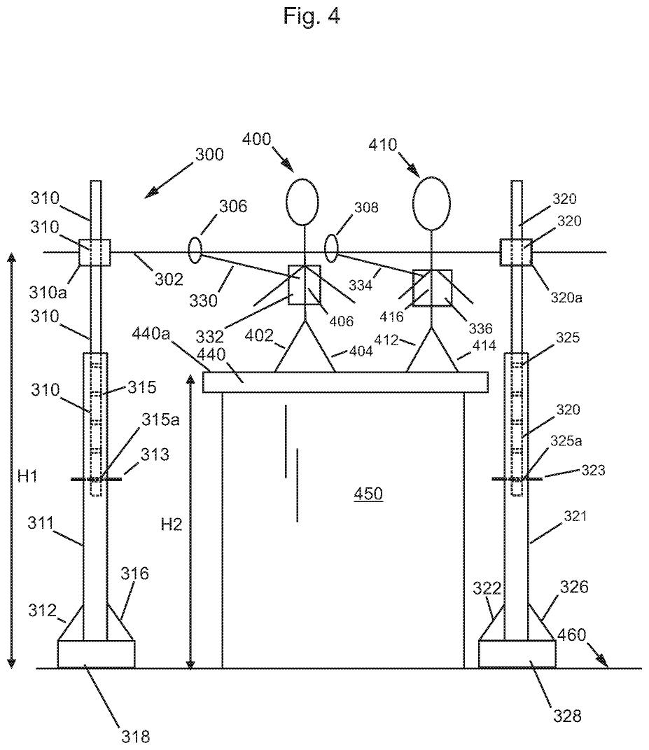

FIG. 4 is a simplified diagram of an apparatus, system, and method 300 in accordance with an embodiment of the present invention, and two simplified renditions of two human beings 400 and 410, and a member 440 supported by support structure 450. The member 440 may have a work surface 440a.

The apparatus, system, and method 300 includes horizontal lifeline, cord, rope, cable or members 302; posts or members 310 and 320; posts or members 311 and 321, supports or members 312, 316, 322, and 326, and bases 318 and 328. The apparatus, system, and method 300 further includes rings or attachment devices 306 and 308, cords 330 and 334, and jackets or harnesses 332 and 336. The apparatus 300 may further include locking members or pins 313 and 323.

The post or member 310 and the post or member 311 may be hollow cylinders. The post or member 310 may have an outer diameter which is smaller than the inner diameter of the post 311 to allow the post or member 310 to slide inside of an inner chamber of the post 311. The post or member 310's position within the post or member 311 can be adjusted to adjust the overall height of the combination of the member 310 and the member 311, which thereby may be used to adjust the height of an attachment device 310a which is attached to the member 310 as shown in FIG. 4. The pin 313 or pins may be inserted into one or more of the openings or slots 315, such as through the opening or slot 315a as shown in FIG. 4 to hold the member 310 at a position with respect to the member 311 so that the top of member 310 is above the top of member 311. The pin 313 can be taken out of the slot 315a, the member 310 can be lowered with respect to the member 311, and then the pin can be inserted into one of the other of the plurality of slots 315.

The post or members 320 and 321 may function identically or similarly to the post or members 10 and 311. The post or member 320 and the post or member 321 may be hollow cylinders. The post or member 320 may have an outer diameter which is smaller than the inner diameter of the post 321 to allow the post or member 320 to slide inside of an inner chamber of the post 321. The post or member 320's position within the post or member 321 can be adjusted to adjust the overall height of the combination of the member 320 and the member 321, which thereby may be used to adjust the height of an attachment device 320a which is attached to the member 320 as shown in FIG. 4. The pin 323 or pins may be inserted into one or more of the openings or slots 325, such as through the opening or slot 325a as shown in FIG. 4 to hold the member 320 at a position with respect to the member 321 so that the top of member 320 is above the top of member 321. The pin 323 can be taken out of the slot 325a, the member 320 can be lowered with respect to the member 321, and then the pin 323 can be inserted into one of the other of the plurality of slots 325.

Although the members 310 and 320 are shown as having a smaller diameter than the members 311 and 321, respectively, in another embodiment, the members 310 and 320 may be larger in diameter than the members 311 and 321, allowing the larger members 310 and 320 to slide up and down on the members 311 and 321. However, it is preferred, in at least one embodiment that the members 311 and 321 be larger in inner diameter than the outer diameter of the members 310 and 320, respectively, as in FIG. 4, to provide a stronger lower portion and stronger support for the apparatus 300.

The human being or person 400 may have legs 402 and 404 and trunk or torso 406. The human being or person 410 may have legs 412 and 414 and trunk or torso 416.

The horizontal lifeline, cord, rope, cable or member 302 may be made of optional materials to include but not limited to wire cable, wire alloy cable, Steel cable, Galvanized steel cable, Polypropylene rope, any rope, Synthetic rope, Polyester rope, structural steel, any metals, composite materials that will achieve horizontal fall protection regulatory requirements and specifications of the Occupational Safety and Health Administrations (OSHA CFR 1910 General Industry/OSHA CFR 1926 Construction) and the American National Specifications Institute (ANSI).

The posts or members 310 and 320 may be made of structural steel, plastic, composite materials such as any steel or metals and other materials that will achieve such structural fall protection design standards that are in compliance within engineering design specifications of the Occupational Safety and Health Administrations (OSHA CFR 1910 General Industry/OSHA CFR 1926 Construction) and the American National Specifications Institute (ANSI).

The supports or members 312, 314, 316, 322, 324, and 326, and bases 318 and 328 may be made of structural steel, plastic, composite materials such as any steel or metals and other materials and temporary anchors that will achieve such structural fall protection design standards that are in compliance within engineering design specifications of the Occupational Safety and Health Administrations (OSHA CFR 1910 General Industry/OSHA CFR 1926 Construction) and the American National Specifications Institute (ANSI).

The rings or attachment devices 306 and 308, cords 330 and 334, and jackets or harnesses 332 and 336 may be made of plastic, composite materials such as any steel or metals, wire cable, alloys, steel, galvanized steel, nylon, polypropylene, any rope, synthetic materials, polyester materials, composite synthetic, alloy or metal materials that will achieve horizontal fall protection regulatory requirements and specifications.

The horizontal lifeline cord, rope or cable or members 302 attach to the posts 310 and 320 and move into position manually by a worker or workers on site. The posts 310 and 320 attach to the supports 312, 314, 316, and 322, 324, and 326 with the option of post 310 and corresponding supports 312, 314, and 316 and/or post 320 and corresponding supports 322, 324, and 326 to be manufactured as a single component made of steel, alloy, composite materials or a welded connection or mechanically fastened connection.

The supports 312, 314, 316, may attach to the base by a bolted connection, welded connection, any structural connection or connection manufactured as a single connection piece or mechanically fastened connection. The supports 322, 324, and 326 may attach to the base 328 by a bolted connection, welded connection, any structural connection or connection manufactured as a single connection piece or a mechanically fastened connection.

The bases 318 and 328 rest on a typically horizontal ground surface 460.

The typically vertical posts 310 and 320 can be raised manually by workers on site into position. The member 440 is independent of the apparatus, method, and system 300 for horizontal fall protection. The member 440 is typically not physically connected to posts 310 and 320. Member 440 and member 450 may be components for a fixed permanent surface/structure or a temporary work surface, structure, platform, or deck used by workers as a surface to work from. Vertical posts 310 and 320, base pieces 318, 328, and horizontal lifeline 302 will be placed with the option of all sides adjacent to members 440 and 450. As shown in FIG. 1, the member 440 is not connected to the posts 310 or 320. The member 440 and member 450 may be connected to a separate structure or base

Each of the posts 310 and 320 may be configured and engineered to meet or exceed OSHA CFR 1926 Construction and CFR 1910 General Industry, ANSI, ASSP, ASTM and made of optional materials to include but not limited to structural steel, any metals, composite materials that will achieve fall protection regulatory requirements and specifications.

Each of the posts 310 and 320 may be configured and engineered to meet or exceed and to allow for the optional use of various material sizes and dimensions that will be in accordance in order to achieve the personal fall arrest design requirements and specifications as per OSHA CFR 1926 Construction and CFR 1910 General Industry, ANSI, ASSE/ASSP, ASTM.

Each of the posts 310 and 320 may be configured and engineered to meet or exceed to include but not limited to vertical loads and tensile strength to include live and dead loads. Dead load shall include the weight of workers, and additional weight of workers when standing stationary with personal fall arrest system equipment, tools and materials. Live loads shall allow for the weight of the workers movement when handling materials, walking point to point between connection posts, the weight of the workers, and additional weight of workers when standing stationary with personal fall arrest system equipment, tools and materials.

Each of the posts 310 and 320 may be a vertical post that is adjustable in vertical height. The mechanism used to adjust the height of each of posts 310 and 320 shall be configured and engineered to meet or exceed the OSHA CFR 1926 Construction and CFR 1910 General Industry, ANSI, ASSP, ASTM and made of optional dimensions and materials to include but not limited to structural steel, any metals, composite materials that will achieve fall protection regulatory requirements and specifications. Each of the bases 18 and 28 may connect to a piece of optional materials to include but not limited to structural steel, any metals, composite materials with either a bolted connection, welded connection, any structural connection, mechanically fastened or connection manufactured as a single connection piece.

The components 312, 314, 316, 322, 324, 326 are configured to support the personal fall arrest design requirements and specifications as per OSHA CFR 1926 Construction and CFR 1910 General Industry, ANSI, ASSE/ASSP, ASTM. Post 310 may be connected to supports 312, 314, and 316, and supports 312, 314, and 316 may be connected to base 318, in any known manner which may include bolted connections, welded connections, any structural connection or a connection manufactured as a single connection piece. Similarly or identically post 320 may be connected to supports 322, 324, and 326, and supports 322, 324, and 326 may be connected to base 328, in any known manner which may include bolted connections, welded connections, any structural connection or a connection manufactured as a single connection piece.

FIG. 4 shows a simplified connection mechanism 310a, which connects one end of lifeline 302 to the post 310. FIG. 4 also shows a simplified connection mechanism 320a which connects an opposing end of lifeline 302 to the post 320. The connection mechanisms 310a and 320a are typically at a minimum height H1 of four feet above the horizontal ground surface 460. The connection mechanism 310a may be attached to the member 310, and one end of the lifeline may be attached to the connection mechanism 310a. The connection mechanism 320a may be attached to the member 320, and an opposing end of the lifeline 302 may be attached to the connection mechanism 320a. The connection mechanism 310a may be connected or locked by a pin or more than one pin, similar or identical to pin 313 to the member 310. Similarly or identically the connection mechanism 320a may be connected or locked by a pin or more than one, similar or identical to pin 323 to the member 320. The connections mechanisms 310a and 320a may be adjusted to adjust the height of mechanisms 310a and 320a above the ground surface 460 without adjusting the members 310 and 320 with respect to the members 311 and 321, respectively.

The connection mechanisms 310a and 320a may include a fastening device such as metal clips, crimped connection, screw connection, pin connection, rivet, bolted connection, welded connection, mechanical fastening, and have the optional materials to include but not limited to steel, any metals, alloys, composite materials, and plastics to allow for the horizontal lifeline or member 302 to connect to post 310 and 320, and to span from post 310 to post 320 hence creating a horizontal lifeline fall protection device, method, apparatus, and/or system. The connection mechanisms 310a and 320a shall have the option to be at a height H1 of four foot minimum and designed with materials and dimensions to meet or exceed OSHA CFR 1926 Construction and CFR 1910 General Industry, ANSI, ASSP, ASTM and made of optional materials to include but not limited to structural steel, any metals, composite materials, fiber rope. The connection mechanisms or devices 310a and 320a, in at least one embodiment, is configured to allow for the optional use of various material sizes and dimensions that will be in accordance with the personal fall arrest design requirements and specifications as per OSHA CFR 1926 Construction and CFR 1910 General Industry, ANSI, ASSE/ASSP, ASTM. Connection mechanisms 310a and 320a shall have the option to include either a fastening device such as metal clips, crimped connection, screw connection, pin connection, rivet, bolted connection, welded connection, mechanical fastening, and have the optional materials to include but not limited to steel, any metals, composite materials, alloys and plastics and may be configured and engineered to include but not limited to meet or exceed the vertical loads and tensile strength to include live and dead loads. Dead load shall include the weight of workers, and additional weight of workers when standing stationary with personal fall arrest system equipment, tools and materials. Live loads shall allow for the weight of the workers movement when handling materials, when walking point to point between connection posts, the weight of the or a workers, and additional weight of workers when standing stationary with personal fall arrest system equipment, tools and materials. The connection mechanisms 310a and 320a, where the lifeline or member 302 is connected to posts 310 and 320, respectively, meet together when at a minimum height of four foot in height, H1. The mechanisms 310a and 320a may connect the posts 310 and 320, respectively, with first and second ends of the lifeline or member 302 with optional material that shall support the personal fall arrest design requirements and specifications as per OSHA CFR 1926 Construction and CFR 1910 General Industry, ANSI, ASSE/ASSP, ASTM.

The lifeline cord or member 302 may be configured and engineered to meet or exceed OSHA CFR 1926 Construction and CFR 1910 General Industry, ANSI, ASSP, ASTM and made of optional materials to include but not limited to Wire cable, Wire alloy cable, Steel cable, Galvanized steel cable, Polypropylene rope, any rope, Synthetic rope, Polyester rope, structural steel, any metals, composite materials that will achieve horizontal fall protection regulatory requirements and specifications. The lifeline cord or member 302 may be configured and engineered to meet or exceed and to allow for the optional use of various material sizes and dimensions that will be in accordance in order to achieve the personal fall arrest design requirements and specifications as per OSHA CFR 1926 Construction and CFR 1910 General Industry, ANSI, ASSE/ASSP, ASTM.

The lifeline cord or member 302 may be configured and engineered to meet or exceed to include but not limited to vertical loads and tensile strength to include live and dead loads. Dead load shall include the weight of workers, and additional weight of workers when standing stationary with personal fall arrest system equipment, tools and materials. Live loads shall allow for the weight of the workers movement when handling materials, walking point to point between connection posts, the weight of the or a workers, and additional weight of workers when standing stationary with personal fall arrest system equipment, tools and materials.

The posts 310 and 320 are typically adjustable in vertical height. The span of the cord or member 302 shall be optional when used as the horizontal lifeline to span post 310 to post 320 and shall typically be configured and engineered to meet or exceed the OSHA CFR 1926 Construction and CFR 1910 General Industry, ANSI, ASSP, ASTM and made of optional dimensional lengths and materials to include but not limited to Wire cable, Wire alloy cable, Steel cable, Galvanized steel cable, Polypropylene rope, Synthetic rope, Polyester rope, any rope, structural steel, any metals, composite materials that will achieve fall protection regulatory requirements and specifications.

The beam or member 440 may have an elevated work surface 440a, which is a minimum of four feet in height, H2 above the ground surface 460 below.

The beam or member 440 has a work surface 440a by which a worker or workers, such as persons 400 and 410, for all construction/trades may stand on when building any structure, assembling materials, demolishing materials, handling material. The beam or member 440 may be a temporary structure or stand on such a structure 450, a permanent structure, a structure being assembled or demolished or all work surfaces and platforms from which to work from. The posts 310 and 320, the lifeline or cord 302, the connection mechanisms 310a and 320a, the beam or member 440 and member 450, the supports 312, 314, 316, 322, 324, 326, and bases 318 and 328 are used in at least one embodiment to aid workers and prevent workers from falling from a minimum height of four feet or greater when working on an elevated work surface 440a. The horizontal span/distance of posts 310 and 320, lifeline 302, and supports 312, 314, 316, 322, 324, and 326, and bases 318 and 328 shall have the option in horizontal distance to span post 310 to post 320 to be configured and engineered to meet or exceed the OSHA CFR 1926 Construction and CFR 1910 General Industry, ANSI, ASSP, ASTM.

The supports 312, 314, 316, 322, 324, 326, and bases 318 and 328 support their corresponding vertical post of posts 310 and 320 to allow the posts 310 and 320 to stand vertically upright. The supports 312, 314, 316, 322, 324, 326 and bases 318 and 328 may be configured and engineered to meet or exceed OSHA CFR 1926 Construction and CFR 1910 General Industry, ANSI, ASSP, ASTM and made of optional materials to include but not limited to structural steel, any metals, composite materials that will meet or exceed the fall protection regulatory requirements and specifications. The supports 312, 314, 316, 322, 324, 326, and bases 318 and 328 may be configured and engineered to meet or exceed and to allow for the optional use of various material sizes and dimensions that will meet the specification requirements for personal fall arrest design and specifications as per OSHA CFR 1926 Construction and CFR 1910 General Industry, ANSI, ASSE/ASSP, ASTM.

The supports 312, 314, 316, 322, 324, and 326 and bases 318 and 328 may be configured engineered to meet or exceed to include but not limited to vertical loads and tensile strength to include live and dead loads. Dead load shall include the weight of workers, and additional weight of workers when standing stationary with personal fall arrest system equipment, tools and materials. Live loads shall allow for the weight of the workers movement when handling materials, walking point to point between connection posts, the weight of the worker/or workers, and additional weight of workers when standing stationary with personal fall arrest system equipment, tools and materials. The supports 312, 314, and 316 may be connected to the base 318 and the supports 322, 324, and 326 may be connected to the base 328 by use of structural steel, any metals, composite materials that shall support the personal fall arrest design requirements and specifications as per OSHA CFR 1926 Construction and CFR 1910 General Industry, ANSI, ASSE/ASSP, ASTM.

The posts 310 and 320 may be connected to their respective supports (312, 314, and 316 for post 310 and 322, 324, and 326 for post 320), by for example, but not limited to, a bolted connection, welded connection, any structural connection or connection manufactured as a single connection piece.

The harness 332 and 336 may be equipment used by the respective persons or workers 400 and 410 to prevent continued falls at four feet and above from a working surface 440a. The harness 332 and 336 in combination with their respective lanyards or cords 330 and 334, and rings or attachment devices 306 and 308 may be used as a personal fall arrest apparatus, system, and method as per regulatory requirements that meet or exceed OSHA CFR 1926 Construction and CFR 1910 General Industry, ANSI, ASSE/ASSP, ASTM. Each worker, such as each of persons 400 and 410 shall wear a personal fall arrest system harness, such as harness 332 for person 400 and harness 336 for person 410, when working on an elevated surface 440a at (4) four feet and above the ground surface 460. The components 306, 330, and 332 for worker 400 and the components 308, 334, and 336 for the worker 410, in at least one embodiment, is equipment which stops and arrests the respective worker when the worker falls off of the work surface 440a and off of member 440.

The cords or lanyards 330 and 334 are part of equipment used by the corresponding worker of workers 400 and 410 to prevent continued falls at four (4) feet and above on the working surface 440a. The cords 330 and 334 and rings or attachment devices 306 and 308, are used as personal fall arrest system as per regulatory requirements that meet or exceed OSHA CFR 1926 Construction and CFR 1910 General Industry, ANSI, ASSE/ASSP, ASTM. Each worker or workers 400 and 410 shall wear a personal fall arrest system harness, 332 for worker 400 and 336 for worker 410, when working on an elevated surface 440a at four (4) feet and above. The cords or lanyards 330 and 334 in combination with the rings or attachment devices 306 and 308, respectively, shall be, in at least one embodiment, equipment by which is attached to the worker's body harness 332 and 336, respectively, at the worker's body and the other end of the fall protection lanyards 330 and 334 shall be attached to the horizontal lifeline 302 through rings or attachment devices 306 and 308. The attachment of the lanyards 330 and 334 through attachment devices 306 and 308 to the horizontal lifeline 302 stops and arrests the worker from continuous fall at four (4)) foot and above, when the workers 400 and 410 fall off of the beam or member 304.

All structural materials for use with the apparatus, method, and/or system 300 in at least one embodiment, such as the vertical posts 310 and 320, supports 312, 314, 316, 322, 324, and 326, and bases 318 and 328, connection mechanisms 310a and 320a, may be made of structural steel, plastic, composite materials such as steel and other materials that will achieve such structural fall protection design standards that are in compliance within engineering design specifications of the Occupational Safety and Health Administrations—CFR 1910 General Industry (OSHA Subpart A, B, D, I)/CFR 1926 Construction (OSHA Subpart A, B, C, D, E, F, G, H, H, J, K L, M, P, Q, R, T, X, AA, CC), International Safety Equipment Association (ISEA), Scaffold and Access Industry Association (SAIA), and American National Standards Institute (ANSI)/American Society of Safety Engineers/Professionals (ANSI/ASSE/ASSP) Z359 Fall Protection Standard/Safety, Z359.0-2012, Z359.0-2018, Z359.1-2016, Z359.2-2017, Z359.3-2019, Z359.4-2013, Z359.6-2016, Z359.7-2019, Z359.11-2014, Z359.12-2019, Z359.13-2013, Z359.14-2014, Z359.15-2014, Z359.16-2016, Z359.18-2017, Z359.9, Z359.17, Construction Safety ANSI/ASSP Z490.1-2016, ANSI/ASSP A10.32-2012, ANSI/ASSE A10.32-2012, ANSI/ASSP A10.9-2013 (R2018), ANSI/ASSP A10.13-2011 (R2017), ANSI/ASSP A10.16-2009 (R2016), ANSI/ASSP A10.18-2007 (R2012), ANSI/ASSP A10.19-2017, ANSI/ASSP A10.24-2014, ANSI/ASSP A10.25-2017, ANSI/ASSP A10.26-2011 (R2016), ANSI/ASSP A10.27-1998 (R2017), ANSI/ASSP A10.28-2018, ANSI/ASSP A10.32-2012, ANSI/ASSP A10.43-2016, ANSI/ASSP A10.42-2000 (R2017), ANSI/ASSP A10.43-2016, Occupational Health and Safety ANSI/ASSP Z10.0-2019, BS OHSAS 18001/BS OHSAS 18002, BS OHSAS 18001/BS OHSAS 18002, BS OHSAS 18001/BS OHSAS 18002/ISO 14001, BS OHSAS 18001/BS OHSAS 18002/ISO 14001, BS OHSAS 18001/ISO 14001, BS OHSAS 18001/ISO 14001, BS OHSAS 18001/ISO 9001/ISO 14001, ANSI ASC A14.2/ANSI ASC A14.5/ANSI/ASSE A10.8, ANSI/SAIA A92. ASTM—American Society of Testing and Materials International.

Although the invention has been described by reference to particular illustrative embodiments thereof, many changes and modifications of the invention may become apparent to those skilled in the art without departing from the spirit and scope of the invention. It is therefore intended to include within this patent all such changes and modifications as may reasonably and properly be included within the scope of the present invention's contribution to the art.

I claim:

1. An apparatus comprising:
a lifeline having a first end and an opposing second end;
a support structure, wherein the first end and the second end of the lifeline are supported by the support structure such that there is a distance between the first end and the opposing second end; and
a structure for holding one or more persons above a ground surface; and
and wherein the support structure is configured to be moved without causing the structure for holding one or more persons to be moved; and
wherein the structure for holding one or more persons is configured to be moved without causing the support structure to be moved.

2. The apparatus of claim 1 wherein
the support structure includes first and second posts;
wherein each of the first and second posts is configured to be adjusted in height above a ground surface to cause a height of the lifeline above the ground surface to be adjusted.

3. A method comprising the steps of:
setting up a support structure to be independent of a structure for holding one or more persons above a ground surface;
attaching a first end of a lifeline to the support structure and an opposing second end of the lifeline to the support structure so that there is a distance between the first end and the opposing second end; and
wherein the support structure is configured to be moved without causing the structure for holding one or more persons to be moved; and
wherein the structure for holding one or more persons is configured to be moved without causing the support structure to be moved.

4. The method of claim 3 wherein
the support structure includes first and second posts;
wherein each of the first and second posts is configured to be adjusted in height above a ground surface to cause a height of the lifeline above the ground surface to be adjusted.
